(19) United States
(12) Patent Application Publication
(10) Pub. No.: US 2010/0288109 A1
(43) Pub. Date: Nov. 18, 2010

(54) STRINGED INSTRUMENT

(76) Inventor: Jan Van Kelst, Rotselaar (BE)

Correspondence Address: BROWDY AND NEIMARK, P.L.L.C.;624 NINTH STREET, NW, SUITE 300, WASHINGTON, DC, 20001-5303, US

(21) Appl. No.: 12/088,787

(22) PCT Filed: Sep. 29, 2006
(86) PCT No.: PCT/IL06/53571

§ 371 Date: Jul. 9, 2010

(30) Foreign Application Priority Data
Sep. 30, 2005 (BE) 2005/0475

(51) Int. Cl. G10H 3/18

(52) U.S. Cl. 84/726

(57) ABSTRACT

The invention relates to a stringed instrument having two long-shaped parts (1, 2) with a first tail end (3) and a second tail end (4), which involves that on each of these parts (1, 2) between said tail ends (3, 4) strings are strung which extend at a small distance from the surface of the part concerned (1, 2) in a nearly parallel fashion to each other so that these can be subjected to a vibration, which involves said first tail end (3) of each of the parts (1, 2) to collaborate together with amplifying devices (6), and which involves that said first tail end (3) of a first of said parts (1) is located at a first side of the instrument, while said first tail end (3′) of a second of these parts (2) is located at an opposite side of the instrument.

The invention relates to a stringed instrument having two long shaped parts with a first tail end and a second tail end, upon which strings have been strung on each of these parts between the said tail ends. These strings are extended in a nearly parallel fashion at a small distance from the surface belonging to the respective part so that they can be subjected to a vibration, during which the said first tail end of each of the parts collaborates with amplifying devices.

Most known stringed instruments use a mostly wooden construction in the shape of an arm upon whose surface bulging pieces of metal, more specifically frets, are installed at specific distances. The surface of the arm is also called fret-board or fingerboard. Along the length of the arm, strings have been strung. Here, in the vicinity of the tail end of the arm, the string runs across a bridge which can or cannot be adjusted to its height and along its length, while in the vicinity of the other tail end the string runs across a so-called nut in a notch. This nut prevents the strings from shifting in a direction contrariwise to the length. Between this top bridge and the said other tail end a tuning mechanism is provided in order to tighten the strings. Thus, the length of the strings can be adjusted as well as their height in relation to the bridge and they can be tightened to obtain a certain note, depending on the thickness of the string.

Instruments which make use of this concept are e.g. the acoustic and the electric guitar, the acoustic and the electric bass guitar, the banjo, the ukulele, the mandolin and the Chapman Stick. All these instruments have frets. The violin, viola, cello and string bass on the contrary are instruments without frets. The way in which the strings are made to vibrate, by adding energy to the strings so that they start resonating, differs from one instrument to the next, and per instrument various possibilities are available in most cases.

With electric instruments, the signal of a string is converted into an electric signal by means of a copper winding which has been put around a magnetic core. An electric current is generated in the copper winding by the vibrating strings, which is then amplified through an amplifying device which drives a loud-speaker. With acoustic instruments the amplification of the sound is made by a sound box.

Each instrument, such as e.g. a piano, a guitar, a bass guitar, a lap steel guitar or a baritone-guitar, has a number of specific advantages in relation to the other instruments. For example, a piano can be played with ten fingers producing ten different notes simultaneously, while a guitar can produce a maximum of six notes simultaneously. However, on a guitar the strings can be struck in different ways, while a piano can only be played loudly or softly. Furthermore, a bass guitar can produce very low notes, while on a guitar you can transpose by using barré-fingering along the length of the neck. This is indeed not an exhaustive list.

Document U.S. Pat. No. 675,134 describes an instrument that contains various parts which each consist of a so-called Chapman Stick or a guitar arm and which are attached to a common carrier. This type of instrument, however, is not ergonomic and playing it is experienced by most musicians as very unnatural.

The present invention wants to bring together the various advantages and possibilities of expression of these instruments into one instrument, in such a way and in an ergonomically justifiable way that an instrument is obtained which offers a great deal more possibilities of expression than the existing instruments and which, moreover, can be played in a very simple way and in an almost intuitive natural way, which involves reaching a very high degree of playing comfort.

For this purpose, the said first tail end of a first of the said parts is located at a first side of the instrument, while the first tail end of a second of these parts is located at an opposite side of the instrument.

Functionally, the surface of the said parts, facing the strings, has consecutive frets which extend contrariwise to the longitudinal direction of the strings, and the distance between the consecutive frets increases from the said first tail end in the direction of the said second tail end.

In an advantageous way, the instrument contains, according to the invention, a mute with a muting organ which can be shifted by means of control devices between a muting position, which involves this organ to press against the said strings so as to mute vibrations in the latter, and a free position, which involves the said muting organ to contain muting elements with which it presses, in the said muting position, against the said strings, which involves the mutual position of the said muting elements to be adjustable in such a way that for each string individually selected muting can be applied when the muting organ is shifted in the said muting position.

Based on an interesting way of performing of the instrument, according to the invention, this contains at least one fixating element which allows holding a corresponding string in such a way that the latter can freely vibrate between the said first tail end and the fixating element.

Preferably, the fixating element contains a small stick of which the top surface is positioned opposite a corresponding string, and in this top surface there is room for a notch in which the said string fits.

Based on a preferred way of performing of the instrument, according to the invention, each of the said parts contains consecutive strings extending next to each other, which collaborate with electromagnetic recording devices that collaborate with a first and a second exit which need to be connected to an amplifier, which involves each consecutive string to generate a tone higher than the previous one when it vibrates, and which involves the said recording devices to allow the contribution from each string to the signal which is sent to the said first exit to gradually decrease between the string that generates the lowest tone and the string that generates the highest tone, while the contribution from each string to the signal which is sent to the said second exit gradually increases between the string that generates the lowest tone and the string that generates the highest tone.

Other special features and advantages of the present invention will emerge from the following description of some special ways of performing of the instrument, according to the invention. This description is only given as an example and it does not in any way limit the extent of the required protection. The reference numbers used hereafter relate to the figures added here.

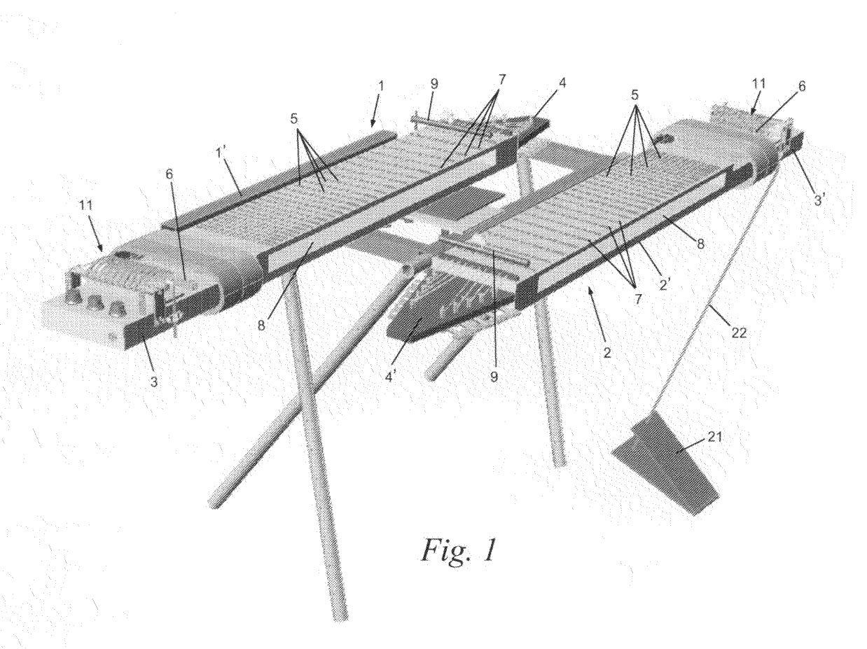

FIG. 1 is a schematic presentation in perspective of a preferred way of performing of an instrument according to the invention.

FIG. 2 is a schematic presentation in perspective of the mute based on an interesting way of performing of the instrument according to the invention.

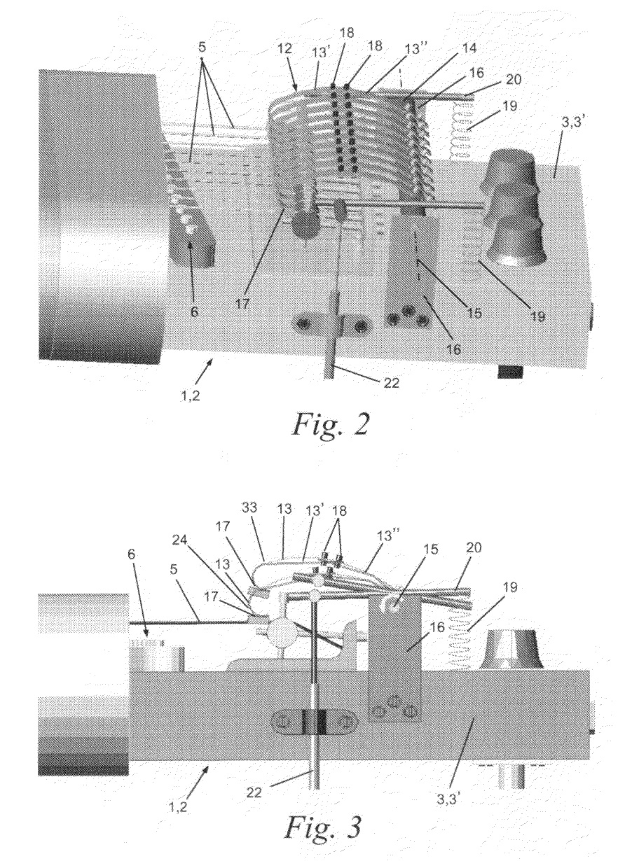

FIG. 3 is a schematic side view of the mute in FIG. 2.

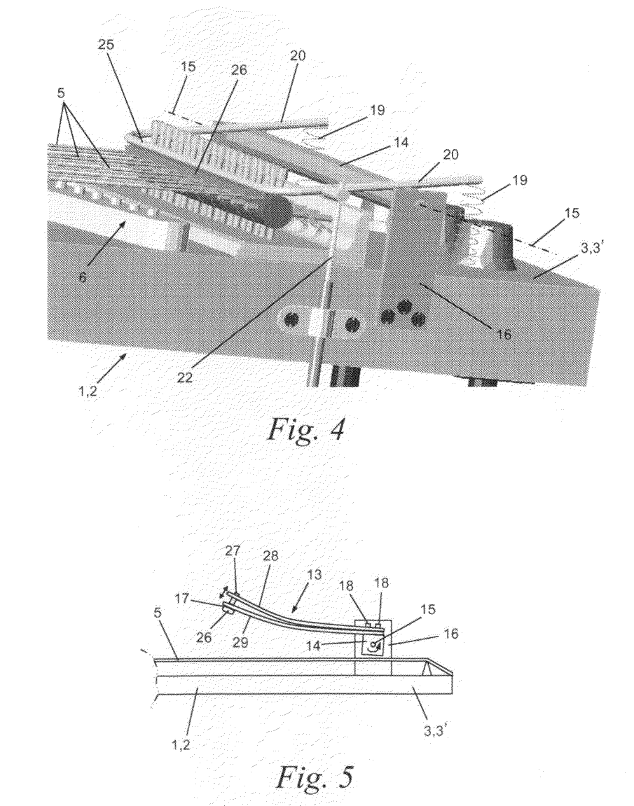

FIG. 4 is a schematic presentation in perspective of the mute based on another way of performing of the instrument according to the invention.

FIG. 5 is a schematic side view of yet another way of performing of a mute of the instrument, according to the invention.

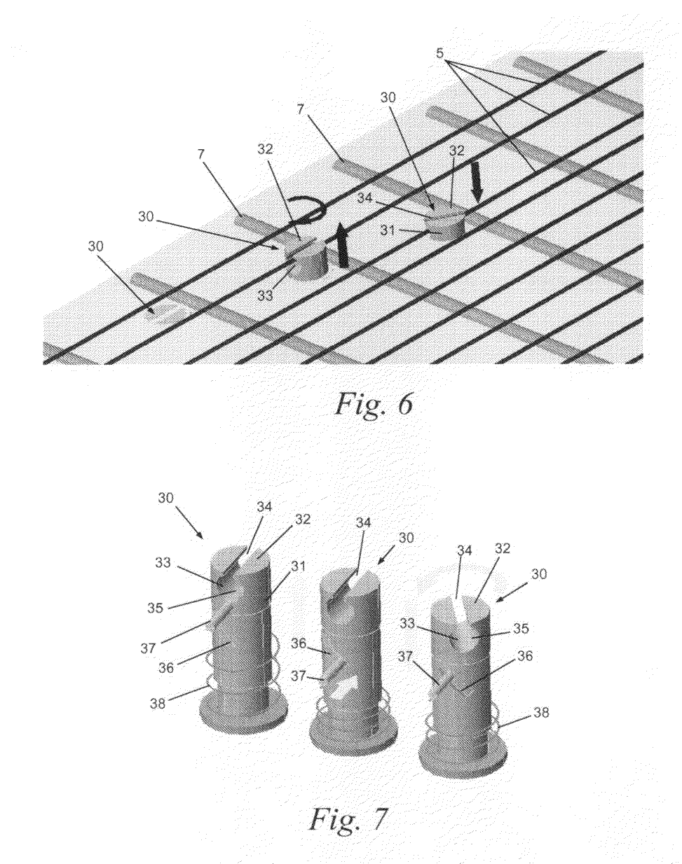

FIG. 6 is a schematic view in perspective of two fixating elements which are installed in an arm of an instrument, according to the invention.

FIG. 7 is a schematic view in perspective of the fixating element in FIG. 6 in various positions.

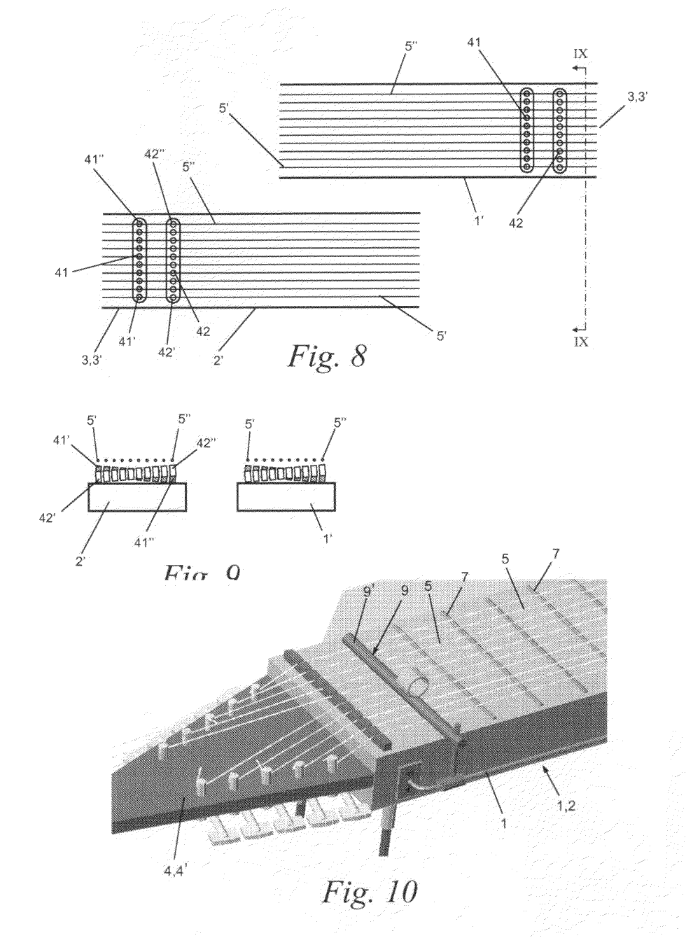

FIG. 8 is a schematic top view of a part of the two arms of the instrument, based on the invention, which involves two series of microphones fitted on each arm.

FIG. 9 is a schematic cross section along the line IX-IX from FIG. 8.

FIG. 10 is a schematic view in perspective of a part of the instrument, according the invention, together with a slide.

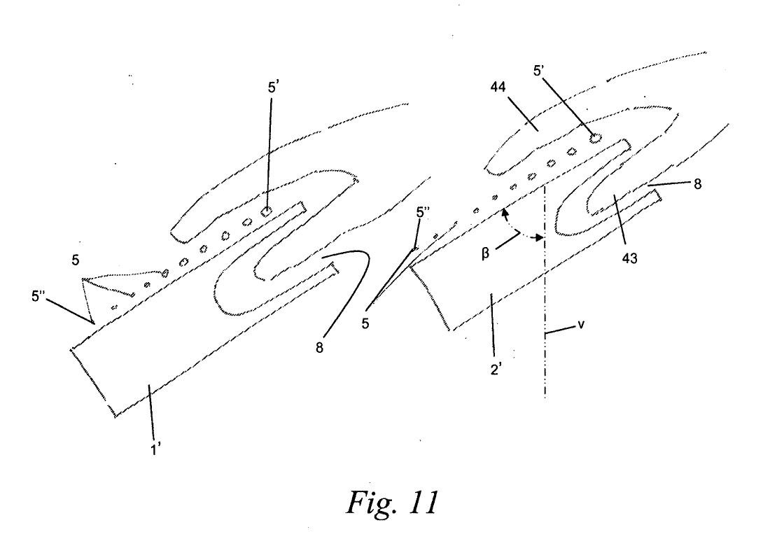

FIG. 11 is a schematic cross section of the instrument, according to the invention, which involves an also very schematic presentation of the hands of a musician who is playing the instrument.

In the various figures, the same reference numbers relate to the same or analogous elements.

Based on an advantageous way of performing of the instrument, according to the invention, this concerns a musical instrument which shows one, two or several arms with or without frets. The totality of an arm with frets is also called a fret-board or fingerboard. Furthermore, this instrument contains strings which collaborate with an electromagnetic receptive element or a sound box which amplifies the sound of the strings. A stand is also provided upon which the arms of the instrument are attached and which allows the player to adjust the height of the arms as well as the angle between the fret-board and the hand, which is used to play on the fret-board concerned, as well as the angle between the various arms. Mutes are provided in order to mute the strings dynamically or statically. The strings of the instrument, according to the invention, are made to vibrate by hammering on them with the fingers, but other techniques are indeed possible. This involves two hands which can play on the instrument independently.

When the sound, generated by the strings, is amplified electrically, the electronics are exported in such a way that the signal of each string, or of groups of strings, can be divided between two exits. The strings which are provided on the instrument can be chosen freely, as well as the way in which they are tuned. If, however, it is decided to tune the strings in fourth intervals, a number of interesting bonuses are obtained as far as the fingering of scales and chords is concerned.

The arms of the instrument are positioned across from each other in such a way that, in order to play a higher note, one always moves the hand away from the centre of the instrument, and this goes for the two hands.

The instrument can contain a number of additional elements such as, for example:

a system which enables the player to ‘slide’ as with a bottleneck on a guitar;

a system which enables the strings to continue resonating also after the fingers have been taken off the strings as would a sustain-pedal on a piano; for this purpose so-called fixating elements are provided which can hold on to the strings after they have been struck so that they continue to vibrate;

a system which increases the vibration of the strings as would an e-bow on a guitar.

FIG. 1 shows a schematic representation in perspective of the stringed instrument, according to the invention. This instrument contains two long-shaped parts 1 and 2. Each of these parts 1 and 2 is for example formed by a long-shaped wooden board. This involves these parts to then form the arms 1′ and 2′ of the instrument.

These parts 1 and 2 both show a first tail end, respectively 3 and 3′, and a second tail end, respectively 4 and 4′. Between the tail ends 3 and 4, respectively 3′ and 4′, of each part 1 and 2, strings have been strung which extend in a nearly parallel fashion to each other at a small distance from the surface of the part 1 or 2 concerned. Thus these strings can be subjected to a vibration.

Said first tail end 3 and 3′ of each of the parts 1 and 2 collaborates with amplifying devices 6. These amplifying devices more specifically contain a series of microphones which have to be connected to an electric amplifier which is not shown in the figures.

In a variant to the way of performing of the invention as presented in FIG. 1, the amplifying devices are formed by a sound box. This type of sound box is then mounted in the vicinity of said first tail end 3 or 3′ and fixed to the latter. A possible type of sound box however is not shown so as to respect the clarity of the figures.

The specific advantageous characteristics of this instrument are obtained to a large extent because said first tail end 3 of a first of the said parts 1 is located at a first side of the instrument, while said first tail end 3′ of a second part 2 is located at an opposite side of the instrument. Thus, preferably, both parts 1 and 2, or in other words the arms 1′ and 2,' are placed across from each other.

In an advantageous way, the longitudinal axes of each of the arms 1′ and 2′ maximally form an angle of 45°.

Preferably, located opposite said strings 5, the surface of said parts 1 and 2 shows consecutive frets 7 which are extended contrariwise on the longitudinal direction of the strings 5, and thus contrariwise on the arms 1′ and 2′. The distance between the consecutive frets 7 increases of said first tail end 3, respectively 3′, in the direction of said second tail end 4, respectively 4′. Thus, the distance between the frets 7 in the vicinity of the first tail end 3 or 3′ is smaller than the distance between the frets 7 in the vicinity of the second tail end 4 or 4′.

Furthermore, the stringed instrument, according to the invention, is fitted in an advantageous way with a so-called static muter of vibrations which allows the vibration of the string 5 to be muted at the said second tail end 4 or 4′. This muter of vibrations consists of for example a strip of elastomer or felt which is woven between the strings 5 at the second tail end 4 and 4′. This is not shown so as to respect the clarity of the figures.

On the side of the instrument which is directed towards the musician who is playing the instrument, a long shaped notch 8 in both parts 1 and 2 is provided across nearly the full useful length of the strings 5. This notch 8 forms a so-called thumb-niche in which the musician can place a thumb when the instrument is played by hammering the remaining fingers on the strings 5.

In order to play in a position in which the hands are strained as little as possible, the strings 5 preferably extend nearly horizontally, while the top surface of parts 1 and 2, or in other words the so-called fret-board, forms an angle β with the vertical V which preferably is smaller than 90° and is located for example between 40° and 80° .It was concluded that, using an utmost ergonomic and naturally experienced position in order to play this instrument, this angle β is greater than 45° and smaller than 75° . The angle β is presented in a schematic way in FIG. 11. The strings 5 extend in a plane which is nearly parallel to the top plane of the respective parts 1 and 2.

Furthermore, parts 1 and 2 of the instrument from FIG. 1 each contain a so-called slide 9 which extends across the strings 5 and makes contact with these strings 5. The slide 9 contains a metal stick 9′ which can thus be shifted along the strings 5 while making contact with them in order to obtain specific sound effects. On the side of the instrument which is directed away from the musician, a guiding rail 10 is provided on each part 1 and 2 for the respective slide 9 in order to allow the slide 9, and more specifically the stick 9′, to shift across the strings 5 along their longitudinal direction. This slide 9 is shown in greater detail in FIG. 10.

At the first tail end 3 and 3′ of at least one of both parts 1 or 2, a so-called dynamic mute 11 is provided. This mute 11 is shown in detail in FIGS. 2 and 3. This mute 11 allows the musician to imitate the muting of the strings of a guitar by means of the hand, more specifically the hitting hand, of a guitar player.

The mute 11 contains a muting organ 12 which can be shifted by using control devices between a muting position, which involves this organ 12 to press against the said strings 5 in order to mute vibrations in the latter, and a free position, which involves the said muting organ 12 not to make contact with the said strings 5. For this purpose, the muting organ 12 contains muting elements 13 with which it presses against the strings 5 in the said muting position.

Each of the said muting elements 13 consists of a long shaped bent strip of material, more specifically spring steel, which stretch parallel to a plane which is perpendicular to a plane in which said strings 5 lie and which is parallel to these strings 5.

In order to allow the muting organ 12 to be shifted with the muting elements between said muting position and said free position, it is mounted on a cylinder-shaped stick 14 which can be rotated around the central axis of this stick 14 which thus forms a rotation axis 15. The stick 14 is attached via two lateral upright supports 16 in the vicinity of said first tail end 3 or 3′ to part 1 or 2.

The muting elements 13 more specifically extend parallel to a plane which is located in a perpendicular position on said rotation axis 15. A tail end of the muting elements 13 is attached to said stick 14, while the other tail end of it forms a contact plane 17 which is pressed against a corresponding string 5 in said muting position. This contact plane 17 is preferably covered with a muting type of material such as rubber or felt.

Furthermore, devices are provided so as to regulate the length of the muting elements 13 along the longitudinal direction of the strings 5. For this purpose, these muting elements 13 consist of two slats 13′ and 13″, extended in line with each other, which overlap along a specific distance. These slats 13′ and 13″ have two screws or bolts 18 on their overlapping part through which they are attached to each other. The length of the muting elements 13 can thus be regulated by adjusting the overlapping section of the two slats 13′ and 13″.

The muting elements 13 have at their tail end, which is attached to said stick 14, a long-shaped notch in which two screws or bolts 18 are provided in order to be attached to stick 14, which involves the possibility to regulate the position of the muting elements with regard to stick 14. This allows for, more specifically, the height of the contact surface 17 to be regulated with regards to the strings 5.

Thus, the mutual position of the muting elements 13, and therefore of the contact planes 17, can be regulated so that for each string 5 an individually chosen muting can be applied when the muting organ 12 is shifted into said muting position.

In order to shift the muting organ 12 into said free position, it collaborates with an elastic element, more specifically two spiral springs 19. These spiral springs 19 are attached with one tail end to said first tail end 3 or 3′ of part 1 or 2 of the instrument, while the other tail end is fixed with an arm 20 which is attached contrariwise to said stick 14. Due to the traction which these springs 19 exert, stick 14 is rotated around its rotational axis into said free position.

The mute 11 further contains control devices which allow it to exert power on the muting organ 12 in order to shift it into said muting position against the action of said springs 19.

These control devices contain a foot pedal 21 which is shown in a schematic way in FIG. 1 and which collaborates with the muting organ 11 via a stick or a pulling cable 22. The stick or pulling cable 22 is, more specifically, fixed with said arm 20 and this is at the tail end of the arm 20 which is located at the other side of the stick 14 as the spring 19. Thus, the power, with which the muting organ 11 presses on the strings 5, and therefore the muting of them, increases in function of the pressure on the foot pedal 21.

FIG. 3 shows a schematic presentation of a muting element 13 in said free position 23 and in said muting position 24.

In a variant of this way of performing, the stick 14 is powered via an electric engine which is driven via a wireless connection with the foot pedal 21.

In another way of performing of the mute 11, which is not shown in the figures, each of the said muting elements 13 contains two relatively stiff sticks. A first stick is permanently linked with regards to said rotational axis 15, while a second stick is mounted on this first stick and it shows a tail end which forms a contact plane 17 which is pressed against a corresponding string 5 in said muting position. The second stick can be shifted, on the one hand along its longitudinal direction and, on the other hand along the longitudinal direction of the first stick, in order to regulate the muting of the corresponding string 5 by the muting element concerned.

For the latter way of performing of the mute, said first stick is preferably movable along the longitudinal direction with regards to said rotational axis in order to regulate the mutual position of said muting elements.

In yet another way of performing of the mute 11, as presented in FIG. 4, said muting organ 12 is formed by a U-shaped stick 25 of which the legs form said arms 20. This U-shaped stick 25 can be rotated around a rotational axis 15 which is fixed via two supports 16 with part 1 or part 2 concerned of the instrument. The part of the stick 25 which connects both arms 20 is provided, on the side which is directed towards said strings 5, with a material 26 which mutes the vibrations, more specifically a strip of rubber or felt. In said muting position, as presented in FIG. 4, this muting material of vibrations presses against the strings 5.

FIG. 5 shows a schematic side view of another variant 10 of a mute 11 according to the invention. This mute 11 contains a muting organ 12 which consists of muting elements 13, extending next to each other, which each are formed with two slats 28 and 29.

The slats 28 and 29 extend parallel to a surface perpendicular to the rotational axis 15 and they are connected at one tail end with the rotational axis 15, while at their other tail end, a distance keeping device 27 is provided. The distance keeping device 27 is formed by a screw which allows the regulation of the slats 28 and 29 between the tail end concerned. The slat 29 which is located opposite a corresponding string 5, has a contact surface 17 upon which is installed a muting material of vibrations 26. In said muting position, this contact plane with the muting material 26 is pressed against the corresponding string 5.

The position of the slats 28 and 29 can be regulated with regards to said stick 14 in order to shift the contact plane along the longitudinal direction of the strings 5. For this purpose, at the tail end of the slats 28 and 29 which is attached to the stick 14, a slot is provided through which screws 18 extend.

Preferably, the mutual position of the contact planes 17, of the various ways of performing of the mute 11 as described above, are chosen in such a way that the angle, across which the various contact planes 17 are rotated around said rotational axis 15 between said free position and said muting position, is nearly equally great.

Based on an interesting way of performing of the instrument, according to the invention, it further contains at least a fixating element 30 which allows holding on to a corresponding string 5 so that the latter can vibrate freely between said first tail end 3 and 3′ and the fixating element 30. When a musician thus hammers with a finger on a certain string 5, the fixating element 30 provides continued vibration of this string 5 after the finger has been removed from the string 5.

An example of such type of fixating element is shown in FIGS. 6 and 7. Even though FIG. 6 only shows two such fixating elements 30, it is possible that under the various strings 5 of the instrument several fixating elements 30 are provided which are distributed across the full length of the strings 5.

Each fixating element 30 is formed by a preferably cylinder-shaped stick 31 which is sunk into the top surface of the corresponding part 1 or 2 of the instrument. This stick 30 shows a head surface 32 which is positioned opposite a corresponding string. In this head surface 32, a notch 33 is provided in which the string 5 concerned fits.

The notch 33 contains a slot 34 which, on the one hand, faces the head surface 32, and on the other hand faces a drilled part 35 with an axis which is nearly parallel to the said slot 34 and which is perpendicular to the central axis of the stick 31. The slot 34 and the drilled part 35 extend across the full width of the stick 31.

Furthermore, devices are provided in order to shift the stick 31 along its axis. This allows the musician, when hammering on a string with a finger, to slightly shift the stick towards the string so that it gets positioned in the drilled part 35 via the slot 34. Subsequently, this stick 31 rotates across a small angle around its axis so that the string is clasped into the notch 33. At the same time the stick is slightly shifted back downwards and away from the surface where the strings are located in a resting position, so that the string, after removing the finger, continues to be in contact with the fret 7 which is located immediately next to the fixating element 30 concerned on the side of said amplifying devices 6. Thus, the string 5, clasped by the fixating element 30 concerned, continues to vibrate after it has been struck.

FIG. 7 shows three consecutive positions of a fixating element 30 without the remaining parts of the instrument. The fixating element 30 shows, in its lateral surface, a long-shaped groove 36 which runs along a helical line across a part of this surface. This groove collaborates with a pin 37 which takes up a fixed position with regards to the part 1 or 2 of the instrument. When the stick 31 is thus shifted along its longitudinal axis, which involves the head plane 32 to remove itself from the plane in which the strings 5 are in a resting position, the groove 36 is lead by the pin 37 in such a way that the stick 31 is subjected to a rotation which involves the string 5 concerned to be grabbed within the notch 33.

When shifting the fixating element 30 back towards the strings, it is subjected to a rotation in the opposite direction so that the string 5 concerned is released.

In order to reinforce the shifting of the fixating element towards the corresponding string 5, it collaborates with a concentric spiral spring 38. The fixating element 30 is handled by means of e.g. a pedal in order to shift it against the power of the spiral spring 38.

Based on another way of performing of the fixating element, according to the invention, it contains an electromagnet which allows the player to hold the said strings 5 against the surface of the part 1 or 2 concerned, or else against a nearby fret 7. In such an instance, the frets 7 are for example formed by an electromagnet which, if desired, can be activated. A string, which is struck, is located closer to a specific fret 7 than the remaining strings. Thus, the strength of the magnetic field of the electromagnet is selected in such a way that only the strings that have been hit are the ones that are pulled against the fret concerned.

The instrument, according to the invention, further offers, in a very interesting way, the possibility to collaborate with two types of electric amplifiers, i.e. a so-called bass amplifier and a so-called guitar amplifier.

More specifically, each of the said parts 1 and 2 contains consecutive strings, extended next to each other, which collaborate with the electromagnetic recording devices 6. The latter collaborate with a first exit 39 and a second exit 40 which each need to be connected to an electric amplifier. This involves each consecutive string 5 to generate a higher tone than the previous string 5 when this one vibrates and the said recording devices are responsible for the gradual decrease of the contribution from each string 5 to the signal which is sent to said first exit, between the string 5 which generates the lowest tone and the string 5 which generates the highest tone. Moreover, the contribution gradually increases from each string 5 to the signal which is sent to said second exit, between the string 5 which generates the lowest tone and the string 5 which generates the highest tone.

Said electromagnetic recording devices are formed by two series of microphones 41, respectively 42, which extend between said strings 5 and the surface of said first 1 and second part 2 of the instrument.

More specifically, a microphone 41 and 42 of each of these series is provided opposite each string 5. This involves the sensitivity of the microphones 41 of the first series to gradually decrease between the string 5′ which generates the lowest tone, or in other words the thickest string, and the string 5″, which generates the highest tone. The latter string 5″ is more specifically formed by the thinnest string of the part concerned of the instrument.

Furthermore, the sensitivity of the microphones 42 of said second series varies gradually between the string 5′ which generates the lowest tone and the string 5″ which generates the highest tone. This involves the sensitivity of the microphone 42, which is placed opposite the thickest string 5′, to be smaller than that of the microphone 42″ which is located opposite the thinnest string 5″. The microphones 41 of said first series are connected to a first exit 39, while the microphones 42 of said second series are connected to said second exit 40.

The microphones 41 of said first series are located next to each other in a nearly straight line. This involves this first series with microphones 41 to be mounted on the surface of the part 1 or 2 concerned under the strings 5 in such a way that the distance between the microphone 41′, which is located opposite the thickest string 5′, is smaller than the distance between the microphone 41″ which is provided opposite the thinnest string 5″.

Furthermore, said second series of microphones 42 also extends along a straight line, which involves the distance between the microphone 42″, which is provided opposite the string 5″, which generates the highest tone, and the latter string 5″, to be smaller than the distance between the string 5′ which generates the lowest tone and the microphone 42′ which lies opposite this string 5′.

Thus, said first exit is for example connected to a so-called bass amplifier and said second exit is connected to a so-called guitar amplifier so that the final sound, which is generated in the speakers that are connected to these amplifiers, has a very gradual transition between low and high tones.

Based on an interesting way of performing of the invention, each of said microphones 41 and 42 are formed by a coil with a magnetic core, which involves the number of windings, out of which the said coil is composed, to be adjusted in function of the sensitivity of the microphone concerned. In such case, it is not required to vary the distance between the microphones and the strings.

FIG. 11 shows a schematic view of the position of both arms 1′ and 2′ of the instrument, according to the invention. This involves the top surface of these arms 1′ and 2′, or in other words the so-called fret-board, to make an angle β with a vertical V. This angle β is not necessarily equal for both arms 1′ and 2′. Furthermore, each of the arms 1′ and 2′, or therefore of the respective parts 1 and 2, is provided with ten strings 5 which extend next to each other and parallel to each other. Based on a preferred way of performing of the invention, on each arm 1′ and 2′ consecutive strings are installed with a different pitch and therefore with a different diameter. This involves for each arm 1′ and 2′ that the string 5″, which generates the lowest tone, is installed on the side which is directed towards the musician, while the string 5″, which generates the highest tone, is the furthest away from the musician. Between this string 5′ with the highest tone and the string 5″ which generates the lowest tone, the thickness of each consecutive string 5 somewhat increases so that each consecutive string 5 generates a nearly lower tone than the previous one.

Preferably, the top surfaces of the arms 1′ and 2′, or in other words the respective fret-boards, are located on a different plane. As is shown in FIG. 11, the plane, in which the fret-board of the arm 1′ most removed from the musician extends itself, is located in a plane which is above the plane in which the fret-board of the other arm 2′ is located.

It is clear that said thumb-niche 8 of both parts 1 and 2 of the instrument faces the musician so that the latter can place the thumbs 43 in it while the tops of the remaining fingers 44 are used to hit the strings. Thus, for each part 1 and 2 of the instrument, the string 5″ which generates the highest tone, is the furthest removed from this thumb-niche 8.

The invention is indeed not limited to the ways of performing of the stringed instrument as described above. Thus, it is possible that for example said microphones consist of a piezoelectric element which generates an electric tension in function of the vibrations generated in the strings.

Furthermore, it is clear that the two arms 1 and 2 of the instrument don't necessarily have to be placed in a relation across from each other, and that they can possibly extend into each other's continuation. Moreover, both arms 1 and 2 can be placed on an adjustable stand, or they can possibly be mounted permanently on the same carrier.

1. Stringed instrument with a long-shaped part (1) with a first tail end (3) and a second tail end (4), wherein between said tail ends (3,4) strings (5) are strung, which extend at a small distance from the surface of the part concerned (1) nearly parallel to each other so that they can be subjected to a vibration, wherein said first tail end (3) collaborates with amplifying devices (6), wherein the instrument contains a mute (11) with a muting organ (12) which can be shifted by means of control devices between a muting position, which involves this organ (12) to press against said strings (5) so as to mute vibrations in the latter, and a free position, wherein said muting organ (12) has muting elements (13) with which it presses in said muting position against said strings (5), characterized in that said control devices comprise a foot pedal collaborating with the muting organ such that the power, with which the muting organ presses on the strings (5), and therefore the muting of them, increases in function of the pressure on the foot pedal.

2. Stringed instrument according to claim 1, characterized in that it comprises a second long-shaped part (2) with a first tail end (3) and a second tail end (4), wherein between said tail ends (3,4) strings (5) are strung, which extend at a small distance from the surface of the part concerned (1) nearly parallel to each other so that they can be subjected to a vibration, wherein said first tail end (3) of each of the parts (1,2) collaborates with amplifying devices (6), whereby said first tail end (3) of a first of said parts (1) is located at a first side of the instrument, while said first tail end (3′) of a second of these parts (2) is located at an opposite side of the instrument.

3. Stringed instrument according to claim 2, characterized in that each of said parts (1,2) forms an arm (1′,2′),which involves the formation between these arms (1′,2′) of an angle that is equal to 45° maximum.

4. Stringed instrument according to claim 1, characterized in that said amplifying devices contain a sound box which is fixed with said first tail end (3, 3′) and which is mounted in the vicinity of the latter.

5. Stringed instrument according to claim 1, characterized in that said amplifying devices contain at least one microphone (41,42) which needs to be connected to an electric amplifier.

6. Stringed instrument according to claim 1, characterized in that the surface of said parts (1,2) opposite said strings (5) shows consecutive frets (7) which extend contrariwise to the longitudinal direction of the strings (5), which involves the distance to increase between the consecutive frets (7) of said first tail end (3,3′) in the direction of said second tail end (4,4′).

7. Stringed instrument according to claim 1, characterized in that devices are provided in order to mute the vibration of the strings (5) at said second tail end (4,4′).

8. Stringed instrument according to claim 7, characterized in that said devices contain a material called elastomer, specifically a strip of elastomer, such as for instance rubber, which is woven between said strings (5).

9. Stringed instrument according to claim 1, characterized in that the mutual position of said muting elements (13) can be regulated so that for each string (5) an individually chosen muting can be applied when the muting organ (12) is shifted in said muting position.

10. Instrument according to claim 1, characterized in that said mute (11) contains devices in order to regulate the position of the muting elements (13) along the longitudinal direction of the strings (5).

11. Instrument according to claim 1, characterized in that said mute (11) contains devices in order to regulate the position of the muting elements (13) along a direction which is perpendicular to the strings (5).

12. Instrument according to claim 1, characterized in that said muting organ (12) collaborates with an elastic element, specifically a spring (19), which exerts a power on the muting organ (12) in order to shift it to said free position.

13. Instrument according to claim 12, characterized in that said control devices allow exerting a power on the muting organ (12) in order to shift it to said muting position against the action of said elastic element (19).

14. Instrument according to claim 1, characterized in that said control devices contain a remote control for shifting said muting organ (12) between said free position and said muting position.

15. Instrument according to claim 1, characterized in that said control devices contain a foot pedal (21) which collaborates via a stick, a pulling cable or electronically with said muting organ (12) in such a way that the power, with which the latter presses against said strings (5), and therefore the muting of them, increases in function of the depression of the foot pedal (21).

16. Instrument according to claim 1, characterized in that said muting organ (12) is movable, between said muting position and said free position, around a rotational axis (15) which is provided for this purpose on the corresponding part (1,2).

17. Instrument according to claim 16, characterized in that each of said muting elements (13) contains two relatively stiff sticks, which involves one first stick to be permanently connected to said rotational axis (15), while a second stick is mounted on this first stick and shows a tail end which forms a plane of contact (17) that is pressed against a corresponding string (5) in said muting position, which involves the second stick to be movable, on the one hand, along its longitudinal direction, and, on the other hand, along the longitudinal direction of the first stick, in order to regulate the muting of the corresponding string (5) by the muting element (13) concerned.

18. Instrument according to claim 17, characterized in that said first stick is movable along its longitudinal direction with regards to said rotational axis (15) in order to regulate the mutual position of said muting elements (13).

19. Instrument according to claim 16, characterized in that each of said muting elements (13) contains a long-shaped bent strip of material which extends parallel to a plane perpendicular to the rotational axis and which is connected, in the vicinity of one tail end, to said rotational axis (15), while its other tail end forms a plane of contact (17) which is pressed against a corresponding string (5) in said muting position, which involves, on the one hand, the provision of means in order to regulate the length of this strip of material along the longitudinal direction of said strings (5), and, on the other hand, the provision of means in order to shift said one tail end along the longitudinal direction of the strip of material with regards to the rotational axis (15).

20. Instrument according to claim 19, characterized in that said strip of material is made of spring steel.

21. Instrument according to claim 16, characterized in that each of said muting elements (13) contains two long-shaped strips of material (13′, 13″), more specifically slats, which extend parallel to a plane perpendicular to the rotational axis (15) and which are connected in the vicinity of one tail end of it with said rotational axis (15), while in the vicinity of the other tail end of it, a distance keeping device (27) is provided which allows regulating the distance between said other tail end of these two strips (13′, 13″), which involves one of these strips to show a plane of contact (17) which is pressed against a corresponding string (5) in said muting position.

22. Instrument according to claim 19, characterized in that the mutual position of the contact planes (17) of said muting organ (13) is regulated in such a way that the angle, across which the various contact planes (17) are rotated around said rotational axis (15), is nearly equally great between said free position and said muting position.

23. Instrument according to claim 1, characterized in that it contains at least one fixating element (30) which allows holding onto a corresponding string (5) so that the latter can vibrate freely between said first tail end (3,3′) and the fixating element (30).

24. Instrument according to claim 23, characterized in that said fixating element (30) contains a stick (31) of which the head surface (32) is positioned opposite a corresponding string (5), which involves this head surface (32) to be provided with a notch (33) in which said string (5) fits.

25. Instrument according to claim 24, characterized in that said notch contains a slot (34) which faces a drilled part (35) with an axis that is nearly perpendicular to said slot (34).

26. Instrument according to claim 23, characterized in that devices are provided which allow shifting the stick (31) along its longitudinal direction.

27. Instrument according to claim 23, characterized in that devices are provided which allow subjecting the stick (31) to a rotational movement in order to grab a string (5) in said notch.

28. Instrument according to claim 23, characterized in that said fixating element (30) contains an electromagnet which allows holding onto said strings (5) against the surface of the part (1,2) concerned, or against a nearby fret (7).

29. Instrument according to claim 1, characterized in that each of said parts (1,2) contains consecutive strings (5) extending next to each other, which collaborate with a first (39) and a second exit (40) that have to be connected to an amplifier, which involves each string (5) to generate a higher tone than the previous one when it vibrates, and which involves said recording devices (6,41,42) to be responsible for the gradual decrease of the contribution of each string (5) to the signal that is sent to said first exit (39) between the string (5′) which generates the lowest tone and the string (5″) which generates the highest tone, while the contribution of each string (5) to the signal that is sent to said second exit (40) gradually increases between the string (5′) which generates the lowest tone and the string (5″) which generates the highest tone.

30. Instrument according to claim 29, characterized in that said electromagnetic recording devices contain two series of microphones (41, 42), which extend between said strings (5) and the surface of said first and/or second part (1, 2), which involves the provision, opposite each string (5) of a microphone (41,42) of each of these series, and which involves the gradual decrease of the sensitivity of the microphones (41) of the first series, that collaborate with said first exit (39), between the string (5′) which generates the lowest tone and the string (5″) which generates the highest tone, while the sensitivity of the microphones (42) of said second series, which collaborate with said second exit (40), gradually increases between the string (5′) which generates the lowest tone and the string (5″) which generates the highest tone.

31. Instrument according to claim 30, characterized in that each of said microphones (6,41,42) contains a coil with a magnetic core, which involves the number of windings, of which said coil is composed, to be adjusted in function of the sensitivity of the microphone concerned.

32. Instrument according to claim 29, characterized in that said electromagnetic recording devices (6) contain a first series of microphones (41) which collaborate with said first exit (39) and which extend along a nearly straight line, which involves that the distance between the microphone (41″) that is provided opposite the string (5″) generating the highest tone and the latter string (5″) is greater than the distance between the string (5′) generating the lowest tone and the corresponding microphone (41′), which involves these recording devices to further contain a second series of microphones (42) which collaborate with said second exit (40) and which also extend along a straight line, which involves that the distance between the microphone (42″) provided opposite the string (5″) that generates the highest tone and the latter string (5″) is smaller than the distance between the string (5′) that generates the lowest tone and the microphone (42′) which lies opposite this string (5′).

33. Instrument according to claim 1, characterized in that it contains a slide (9) which extends contrariwise across the strings (5) of said first and/or second part (1,2), and which makes contact with these strings (5), which involves this slide (9) to collaborate with a guiding rail (10) extending along the longitudinal direction of the strings (5) and which is provided at the respective first and/or second part (1,2), so that the slide (9) can be shifted across the strings (5) along their longitudinal direction.
